(19) United States
(12) Patent Application Publication
(10) Pub. No.: US 2024/0150159 A1
(43) Pub. Date: May 9, 2024

(54) SYSTEM AND METHOD FOR DEFINITION OF A ZONE OF DYNAMIC BEHAVIOR WITH A CONTINUUM OF POSSIBLE ACTIONS AND LOCATIONS WITHIN THE SAME

(71) Applicant: Seegrid Corporation, Pittsburgh, PA (US)

(72) Inventors: Nicholas Alan Melchior, Pittsburgh, PA (US); Andrew Dempsey Tracy, Pittsburgh, PA (US); Benjamin George Schmidt, Wexford, PA (US); Ryan Young, Newtown, PA (US); Livia Phillips, Pittsburgh, PA (US)

(21) Appl. No.: 18/504,927

(22) Filed: Nov. 8, 2023

Related U.S. Application Data
(60) Provisional application No. 63/423,679, filed on Nov. 8, 2022.

(51) Int. Cl. B66F 9/06; B66F 9/075; G01S 17/931

(52) U.S. Cl. CPC B66F 9/063; B66F 9/075; G01S 17/931

(57) ABSTRACT

A robotic vehicle, such as an autonomous mobile robot (AMR), is provided, comprising a chassis, a navigation system, and a load engagement portion, a plurality of sensors, including an object detection sensor, and a load interaction system. The AMR is configured to perform a load drop and a load pickup within a zone without using predetermined load pick up and drop off locations within the zone. The AMR can determine where to place a load within the zone based on proximity to another object or physical structure within the zone. A location of the zone on the AMR's route can be trained, but pickup and drop locations within the zone can be untrained and undefined in advance.

### CROSS REFERENCE TO RELATED APPLICATIONS

The present application claims priority to U.S. Provisional Patent Appl. No. 63/423,679, filed Nov. 8, 2022, entitled System and Method for Definition of a Zone of Dynamic Behavior within a Continuum of Possible Actions and Structural Locations within the Same, which is incorporated herein by reference in its entirety.

The present application may be related to International Application No. PCT/US23/016556 filed on Mar. 28, 2023, entitled A Hybrid, Context-Aware Localization System For Ground Vehicles; International Application No. PCT/US23/016565 filed on Mar. 28, 2023, entitled Safety Field Switching Based On End Effector Conditions In Vehicles; International Application No. PCT/US23/016608 filed on Mar. 28, 2023, entitled Dense Data Registration From An Actuatable Vehicle Mounted Sensor; International Application No. PCT/U.S. Pat. No. 23,016,589, filed on Mar. 28, 2023, entitled Extrinsic Calibration Of A Vehicle-Mounted Sensor Using Natural Vehicle Features; International Application No. PCT/US23/016615, filed on Mar. 28, 2023, entitled Continuous And Discrete Estimation Of Payload Engagement/Disengagement Sensing; International Application No. PCT/US23/016617, filed on Mar. 28, 2023, entitled Passively Actuated Sensor System; International Application No. PCT/US23/016643, filed on Mar. 28, 2023, entitled Automated Identification Of Potential Obstructions In A Targeted Drop Zone; International Application No. PCT/US23/016641, filed on Mar. 28, 2023, entitled Localization of Horizontal Infrastructure Using Point Clouds; International Application No. PCT/US23/016591, filed on Mar. 28, 2023, entitled Robotic Vehicle Navigation With Dynamic Path Adjusting; International Application No. PCT/US23/016612, filed on Mar. 28, 2023, entitled Segmentation of Detected Objects Into Obstructions and Allowed Objects; International Application No. PCT/US23/016554, filed on Mar. 28, 2023, entitled Validating the Pose of a Robotic Vehicle That Allows It To Interact With An Object On Fixed Infrastructure; and International Application No. PCT/US23/016551, filed on Mar. 28, 2023, entitled A System for AMRs That Leverages Priors When Localizing and Manipulating Industrial Infrastructure; International Application No.: PCT/US23/024114, filed on Jun. 1, 2023, entitled System and Method for Generating Complex Runtime Path Networks from Incomplete Demonstration of Trained Activities; International Application No.: PCT/US23/023699, filed on May 26, 2023, entitled System and Method for Performing Interactions with Physical Objects Based on Fusion of Multiple Sensors; International Application No.: PCT/US23/024411, filed on Jun. 5, 2023, entitled Lane Grid Setup for Autonomous Mobile Robots (AMRs); to U.S. Provisional Patent Appl. No. 63/410,355 filed on Sep. 27, 2022, entitled Dynamic, Deadlock-Free Hierarchical Spatial Mutexes Based on a Graph Network; U.S. Provisional Appl. No. 63/423,538, filed Nov. 8, 2022, entitled Method for Calibrating Planar Light-Curtain; U.S. Provisional Appl. No. 63/423,683, filed on Nov. 8, 2022, entitled System and Method for Optimized Traffic Flow Through Intersections with Conditional Convoying Based on Path Network Analysis; U.S. Provisional Appl. No. 63/430,184 filed on Dec. 5, 2022, entitled Just in Time Destination Definition and Route Planning; U.S. Provisional Appl. No. 63/430,190 filed on Dec. 5, 2022, entitled Configuring a System that Handles Uncertainty with Human and Logic Collaboration in a Material Flow Automation Solution; U.S. Provisional Appl. No. 63/430,182 filed on Dec. 5, 2022, entitled Composable Patterns of Material Flow Logic for the Automation of Movement; U.S. Provisional Appl. No. 63/430,174 filed on Dec. 5, 2022, entitled Process Centric User Configurable Step Framework for Composing Material Flow Automation; U.S. Provisional Appl. No. 63/430,195 filed on Dec. 5, 2022, entitled Generation of “Plain Language” Descriptions Summary of Automation Logic; U.S. Provisional Appl. No. 63/430,171 filed on Dec. 5, 2022, entitled Hybrid Autonomous System Enabling and Tracking Human Integration into Automated Material Flow; U.S. Provisional Appl. No. 63/430,180 filed on Dec. 5, 2022, entitled A System for Process Flow Templating and Duplication of Tasks Within Material Flow Automation; U.S. Provisional Appl. No. 63/430,200 filed on Dec. 5, 2022, entitled A Method for Abstracting Integrations Between Industrial Controls and Autonomous Mobile Robots (AMRs); and U.S. Provisional Appl. No. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. patent application Ser. No. 11/350,195, filed on Feb. 8, 2006, U.S. Pat. No. 7,466,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; US Design Patent Appl. 29/398,127, filed on Jul. 26, 2011, U.S. Pat. No. D680,142, Issued on Apr. 16, 2013, entitled Multi-Camera Head; US Design Patent Appl. 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 17/712,660, filed on Apr. 4, 2022, US Publication Number 2022/0297734, Published on Sep. 22, 2022, entitled Laterally Operating Payload Handling Device; U.S. patent application Ser. No. 16/892,549, filed on Jun. 4, 2020, U.S. Pat. No. 11,693,403, Issued on Jul. 4, 2023, entitled Dynamic Allocation And Coordination of Auto-Navigating Vehicles and Selectors; U.S. patent application Ser. No. 18/199,052, filed on May 18, 2023, Publication Number______, Published on______, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022/0100195, Published on Mar. 31, 2022, entitled Vehicle Object-Engagement Scanning System And Method; U.S. patent application Ser. No. 17/478,338, filed on Sep. 17, 2021, US Publication Number 2022/0088980, Published on Mar. 24, 2022, entitled Mechanically Adaptable Hitch Guide; U.S. patent application Ser. No. 29/832,212, filed on Mar. 25, 2022, entitled Mobile Robot, each of which is incorporated herein by reference in its entirety.

### FIELD OF INTEREST

The present inventive concepts relate to systems and methods in the field of autonomous mobile robot and/or robotic vehicles. Aspects of the inventive concepts are applicable to any mobile robotics application involving interactions with physical objects.

### BACKGROUND

Autonomous mobile robots (AMRs) are readily used for automating material movement to and from storage and staging areas. In order to operate, an AMR is trained to follow a route to repeatedly deliver or retrieve payloads. In some instances, material is stored on pallets at a portion of a trained path that includes a lane zone where the AMR may change directions or otherwise lanes on a floor at a staging area. For example, lanes are often used in dock areas to set up material to be loaded on to or off of trailers, e.g., as part of a shipping and/or receiving operation. In another example, lanes are used as a temporary holding area to keep supplies close to a manufacturing line so that when parts need to be replenished, they are already nearby to be moved to the line quickly. As material comes in, it can be placed into the lanes and as it can then be removed from the lanes as needed.

AMRs are capable of free navigation to some degree and are used in warehouses or the like where they are required to navigate many routes. However, conventional AMRs rely on specific lanes and are configured to operate according to predetermined routes to move materials into and out of the lanes. Accordingly, individual locations within a lane are independently taught to the AMRs along with paths to and from each location in the lane. Thus, a lane can comprise one or more individual material locations, where a material location can be an area designated for the drop and/or delivery of a load, e.g., a palletized load. This requires significant training time for the AMRs, only allows for specific locations in each lane to be used, and requires significant computer processing for performing complex bookkeeping operations to determine which positions along a path to drop off or retrieve an object such as a palletized load are reachable.

### SUMMARY OF THE INVENTION

The inventive concepts relate to a system and method that allow for a general region to be defined where objects can be added or removed based on reachable positions. In various embodiments, the inventive concepts can enable one or more AMRs to add a load to the deepest reachable position and remove the first load reachable in the region.

In accordance with a general aspect of the inventive concepts, provided is a robotic vehicle, which within a lane zone where there are no predetermined positions for where payloads must be located can determine where payloads within the lane zone are located via a system comprising a plurality of sensors, and then either pick up the closest payload within the lane zone, or else deposit a payload to the farthest unoccupied space within the lane zone.

In accordance with another aspect of the inventive concepts, provided is a method executable by an autonomous mobile robot (AMR), the method comprising: training the AMR to auto-navigate to a zone where at least one task is to be performed, the zone defining a region without predetermined structural locations; the AMR auto-navigating to the zone and, using one or more sensors, determining a presence of an object within the zone; and if the AMR is tasked with picking a load, removing the object from the structural location; or if the AMR is tasked with dropping a load, dropping the load at a position proximate to the object.

In various embodiments, the method includes using a set of object of interest sensors to locate the object within the zone.

In various embodiments, the set of object of interest sensors includes one or more of two dimensional (2D) LiDAR sensors and/or three dimensional (3D) LiDAR sensors.

In various embodiments, the method includes using a set of payload presence sensors to determine if the AMR is carrying a load.

In various embodiments, the set of payload sensors includes one or more of 2D LiDAR sensors and/or physical paddle sensors.

In various embodiments, training the AMR to auto-navigate to the zone does not require training the AMR to navigate within the zone.

In various embodiments, training the AMR to auto-navigate to the zone includes processing user inputs received via a user interface device to mark locations in an electronic representation of an environment encompassing the zone.

In various embodiments, the user interface device is onboard, forming part of the AMR.

In various embodiments, the user interface device is offboard, separate from the AMR.

In various embodiments, determining the object includes determining a structural location closest to the AMR.

In various embodiments, determining the structural location when dropping the load includes, if no structural location is determined by the one or more sensors, designating a farthest position within the zone as the structural location, the farthest position including a near bound and a far bound that define a space within which the load can be dropped.

In various embodiments, the method further comprises, in response to the AMR determining an obstruction prior to the near bound, the AMR stopping and waiting for the obstruction to clear before navigating to the object.

In various embodiments, the method further comprises in response to the AMR reaching the far bound, the AMR dropping the load.

In various embodiments, dropping the load includes calculating a separation distance between the structural location and the load to determine the position.

In various embodiments, the method further comprises using reverse obstruction sensing of the AMR to set a stop distance that maintains the separation distance between the load and the object when dropped at the position.

In various embodiments, the method further comprises determining the position based on the separation distance and a length of the load.

In various embodiments, the structural location is a previously dropped load or a structural element comprising a wall, a column, a table, or a shelving rack.

In various embodiments, picking the load includes picking the load at the object closest to the AMR.

In various embodiments, the method further comprises adjusting sensing by the one or more sensor to be able to remove that load from the zone

In various embodiments, the method further comprises using an object of interest sensor to perform reverse obstruction sensing of the AMR to set a stop distance for performing classification of the object.

In various embodiments, if the AMR reaches an end of the zone without sensing the object, the AMR aborting acquiring the load.

In various embodiments, in response to the AMR using an object of interest classification sensor to perform sensing of the object in the zone, attempting to classify the object as an obstruction or the structural location.

In various embodiments, if the AMR classifies the object as an obstruction, the AMR remains stopped until the obstruction clears.

In various embodiments, if the AMR classifies the object as a structural location, the AMR determining whether the object is a load to be acquired and if the load is in a position where it can be picked.

In various embodiments, if the AMR classifies the object as a structural location, bounding a range of positions where the AMR can physically engage the object.

In various embodiments, if the AMR reaches a far end of the range without detecting the presence of the load with an AMR manipulator, stopping and signaling that the load was not found.

In various embodiments, if the load is detected within the range as being in contact with the AMR's manipulator, the AMR stopping and picking the load.

In various embodiments, the region includes a lane comprising linearly arranged structural locations.

In various embodiments, the method further comprises training the AMR to navigate the region and/or lane by reversing direction to exit the region and/or lane after a drop task or a pick task.

In accordance with another aspect of the inventive concepts, provided is An autonomous mobile robot (AMR), comprising: a chassis; a navigation system that auto-navigates the AMR to a zone where at least one task is to be performed in the absence of the AMR trained to navigate within the zone; a plurality of sensors including a payload presence sensor, an object of interest detection sensor, and an object of interest classification sensor; and a payload engagement system configured to exchange information with the plurality of sensors, and, using the sensors, configured to determine a position of an object within a predefined zone in order to determine where to perform a deposition in a load drop mode or a removal of an object in a load engagement mode within the zone.

In various embodiments, the object is a pickable object comprising one of a pallet, a cage, or a container.

In various embodiments, the object of interest sensor is constructed and arranged to locate the object within the zone.

In various embodiments, the object of interest sensor includes one or more of two dimensional (2D) LiDAR sensors and/or three dimensional (3D) LiDAR sensors.

In various embodiments, the payload presence sensor determines if the AMR is carrying a load.

In various embodiments, the payload presence sensor includes one or more of 2D LiDAR sensors and/or physical paddle sensors.

In various embodiments, the object of interest classification sensor performs sensing of the object in the zone, attempting to classify the object as an obstruction or the location.

In various embodiments, if the AMR classifies the object as an obstruction, the AMR remains stopped until the obstruction clears.

In various embodiments, the AMR classifies the object as a location, the AMR determining whether the object is a load to be acquired and if the load is in a position where it can be picked.

In various embodiments if the AMR classifies the object as a location, bounding a range of positions where the AMR can physically engage the object.

In various embodiments if the AMR reaches a far end of the range without detecting the presence of the load with an AMR manipulator, stopping and signaling that the load was not found.

In various embodiments if the load is detected within the range as being in contact with the AMR's manipulator, the AMR stopping and picking the load.

In accordance with another aspect of the inventive concepts, provided is an autonomous mobile robot (AMR), comprising: a chassis, a navigation system, and a load engagement portion; a plurality of sensors, including an object detection sensor and a load presence sensor; and a load interaction system configured to exchange information with the plurality of sensors, and, using the sensors, configured to determine a position of an object within a predefined zone in order to determine where to perform a deposition in a load drop mode and a removal in a load engagement mode within the zone.

In various embodiments, the mobile robot further comprises a graphical interface configured to train the AMR with the zone.

In various embodiments, the object detection sensor is configured to locate a position of an object withing the zone.

In various embodiments, the load presence sensor is configured to determine whether the AMR is carrying an object.

In various embodiments, in the load drop mode, the load interaction system is configured to determine a position of a closest object within the zone and the AMR is configured to deposit an object in proximity to the closest object.

In various embodiments, in the load drop mode, the AMR configured to deposit an object in the deepest reachable position within the zone.

In various embodiments, in the load engagement mode, the load interaction system is configured to determine a position of a closest object within the zone and the AMR is configured to remove the closest object.

In various embodiments, in the load engagement mode, the AMR configured to remove a first object within the zone.

In accordance with another aspect of the inventive concept, provided is a load interaction method of an autonomous mobile robot (AMR), comprising: providing the AMR including: a chassis, a navigation system, and a load engagement portion; a plurality of sensors, including an object detection sensor and a load presence sensor; and a load interaction system; and the load interaction system exchanging information with the plurality of sensors and, using the sensors, determining a position of an object within a predefined zone in order to determine where to perform a deposition in a load drop mode and a removal in a load engagement mode within the zone.

In various embodiments, the method further comprising training the AMR with the zone using a graphical interface.

In various embodiments, the object detection sensor is configured to locating a position of an object withing the zone.

In various embodiments, the load presence sensor determining whether the AMR is carrying an object.

In various embodiments, in the load drop mode, the load interaction system determining a position of a closest object within the zone and the AMR depositing an object in proximity to the closest object.

In various embodiments, in the load drop mode, the AMR depositing an object in the deepest reachable position within the zone.

In various embodiments, in the load engagement mode, the load interaction system determining a position of a closest object within the zone and the AMR removing the closest object.

In various embodiments, in the load engagement mode, the AMR removing a first object within the zone.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1 is a perspective view of an embodiment of an AMR lift truck that is equipped and configured to drop off and pick up objects, in accordance with aspects of the inventive concepts.

FIG. 2 is another perspective view of the AMR lift truck of FIG. 1.

FIG. 3 is a block diagram of an embodiment of an AMR, in accordance with aspects of the inventive concepts.

FIG. 4 is a flow diagram of an embodiment of a method for determining reachability of a position at which an AMR is expected to drop off an object, in accordance with aspects of the inventive concepts.

FIG. 5 is a flow diagram of an embodiment of a method for determining reachability of a position at which an AMR is expected to pick up an object, in accordance with aspects of the inventive concepts.

FIG. 6A is a diagram of an embodiment of an AMR performing a load drop off operation at a specified zone, in accordance with aspects of the inventive concepts.

FIG. 6B is a diagram of an embodiment of an AMR performing a load pick up operation from the specified zone of FIG. 6A, in accordance with aspects of the inventive concepts.

FIG. 7 is an example screenshot of a graphical user interface for training an AMR.

### DESCRIPTION OF PREFERRED EMBODIMENT

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

To the extent that functional features, operations, and/or steps are described herein, or otherwise understood to be included within various embodiments of the inventive concepts, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

As described above, conventional autonomous mobile robots (AMRs) must be trained to navigate a route and move objects (e.g., palletized loads, carts, or other loads) at defined locations within a lane along the route, which is both time consuming and requires a lot of book-keeping to determine which objects are reachable at a given location in the lane at a particular time when the AMR is expected to remove the object, e.g., a pallet or other load, from the position. The object, or object of interest, and its location within the lane are part of the trained data used by the AMR. To address the foregoing, the inventive concepts relate to a system and method that allow for a general region or zone to be defined, where objects (e.g., palletized loads or other forklift loads) can be added or removed based on locations within the zone that are determined by the AMR to be reachable using sensor data. In various embodiments, this can include adding (or “dropping”) an object to the deepest reachable location within the zone and/or removing (or “picking”) the first object, e.g., a palletized load, that is determined to be reachable in the zone, or the region. The entrance and/or exit of the zone can be determined and defined during training of the AMR and far and near bounds of the zone can be defined for placing or removing objects, such palletized payloads.

The determination of whether a location within a zone is reachable is made automatically by the AMR based on sensor data, collected in real-time. More specifically, embodiments of the present inventive concept include sensors and related systems that determine where to perform either a payload acquisition (pick) or deposit (drop) within a zone without prior knowledge of the location of objects within the zone. In various embodiments, the AMR can possess prior knowledge of a location of the zone and the functionality to perform a payload acquisition or deposit within the zone in response to sensing objects among various locations within the zone. In some embodiments, additionally or alternatively, the sensing functions can be provided or augmented by one or more offboard sensors, e.g., within the environment, and/or onboard one or more other AMRs. For example, a route training process may be executed so that a zone, such as a lane zone, can accommodate up to five pallets, as a form of objects or objects of interest, in a line within the lane. The system does not require the AMR to know or to be trained to know that there are presently two pallets in the lane zone, or where within the lane zone they are placed ahead of time. The system can collect information from sensors on the AMR to determine at runtime where the pallets are within the lane zone and either acquire the first pallet it can reach or deposit a pallet next to the first pallet it finds, depending on the task of the AMR. This allows the AMR to be dispatched without specifying and training a specific position within the lane zone in advance of a payload delivery. Therefore, the zone need not comprise a set of predefined drop off and/or pickup locations or spaces. In various embodiments, the zone can be a region having a defined exit and entrance, a near bound, a far bound, and a plurality of undefined locations configured for object acquisition and/or deposition. The near bound and the far bound, as electronically defined, can be treated as objects by the AMR when determining the metes and bounds of the zone for dropping or picking objects.

In various embodiments, the system and method allow an AMR to navigate to a zone and then use sensing systems to determine the location of a closest object within the zone, e.g., a palletized load, in order to either remove it from the region (pick), or else to place a new object in proximity to it (drop). The system and method allow for an indeterminate number of object locations to be used, by specifying a zone where the actions of adding to or removing from the zone may be performed, allowing for as much or as little of that zone to be used as needed without the need to keep track of precise positions within the zone.

In various embodiments, the system and method greatly reduce the amount of training needed for the AMRs, as the locations where objects are to be dropped or picked within a zone do not need to be individually demonstrated via a training exercise. In addition, the system and method do not require bookkeeping as to which object in a lane zone, for example, is reachable, as the AMR will acquire the nearest available object in the lane zone, or deposit a transported object into the deepest part of the zone available.

An embodiment of the system in accordance with the inventive concepts includes an AMR configured to add or remove objects from a specified zone. The specified zone is a region where objects can be placed into or removed from, such that the objects are lined up when they are placed in it, i.e., in a lane zone. In some embodiments, the specified zone is a defined region where actions are performed in proximity to objects without predetermined locations for those objects. The AMR interacts with an object in order to either drop it in the zone or pick it from the zone. In various embodiments, object of interest sensors, also referred to as object detector sensors, on the AMR are used to locate the position of an object within the zone. One or more load presence sensors are used to determine if the AMR is carrying an object. A graphical user interface can be used for training the AMRs with respect to the specified zone and the route to navigate to the zone, but the AMR can determine a specific location within the zone for pick up or drop off operations.

The system and method of the inventive concepts utilizes the sensors to determine the location and position of objects within the specified zone in order to determine where to perform an action within the defined zone, e.g., drop off or pick up.

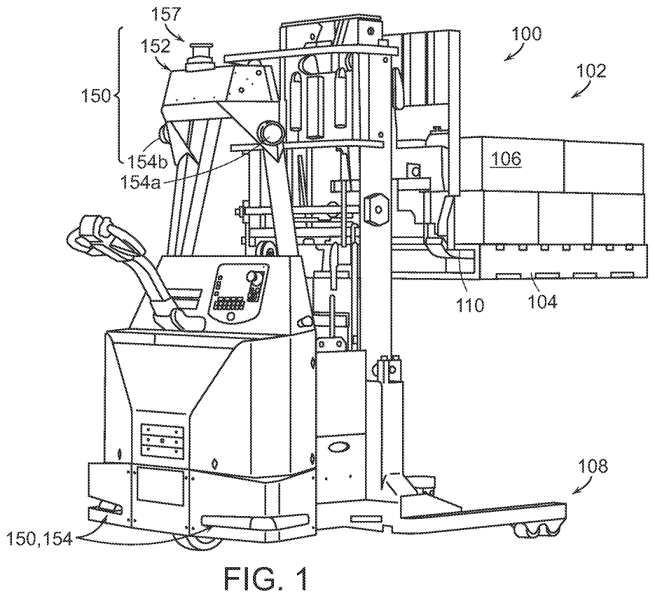

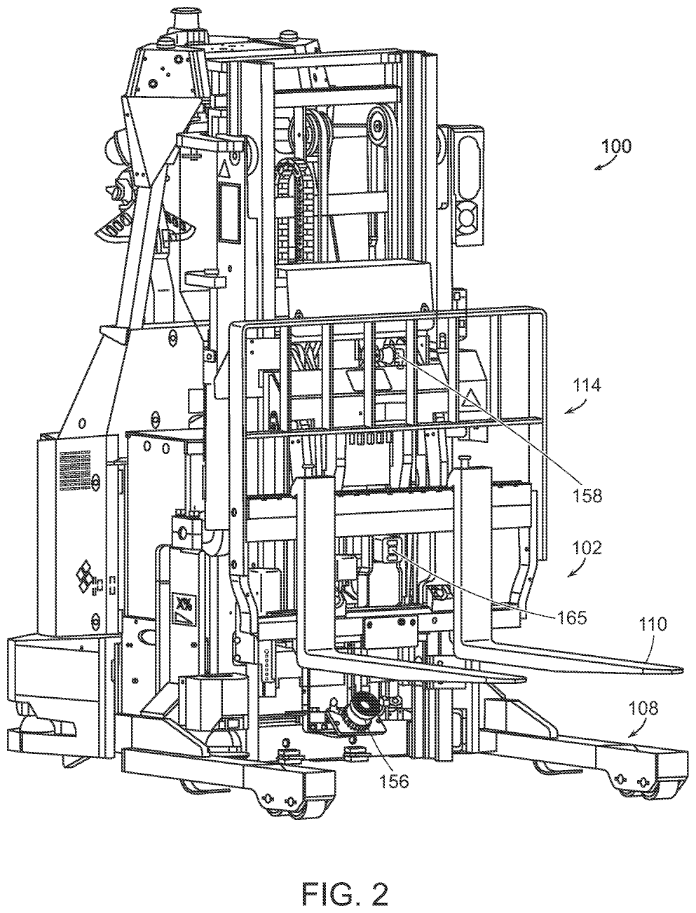

Referring to FIGS. 1 and 2, shown is an example of a self-driving or robotic vehicle in the form of an AMR lift truck 100 that is equipped and configured to drop off and pick up objects, such as palletized loads or other loads, in accordance with aspects of the inventive concepts. Although the robotic vehicle can take the form of an AMR lift truck 100, the inventive concepts could be embodied in any of a variety of other types of robotic vehicles and AMRs, including, but not limited to, forklifts, tow tractors, tuggers, and the like.

In this embodiment, AMR 100 includes a payload area 102 configured to transport any of a variety of types of objects that can be lifted and carried a pair of forks 110. Such objects can include a pallet 104 loaded with goods 106, collectively a “palletized load,” or a cage or other container with fork pockets, as examples. Outriggers 108 extend from the robotic vehicle 100 in the direction of forks 110 to stabilize the AMR, particularly when carrying palletized load 104,106.

Forks 110 may be supported by one or more robotically controlled actuators coupled to a carriage 114 that enable AMR 100 to raise and lower, side-shift, and extend and retract to pick up and drop off objects in the form of payloads, e.g., palletized loads 104,106 or other loads to be transported by the AMR. In various embodiments, the AMR may be configured to robotically control the yaw, pitch, and/or roll of forks 110 to pick a palletized load in view of the pose of the load and/or horizontal surface that supports the load. In various embodiments, the AMR may be configured to robotically control the yaw, pitch, and/or roll of forks 110 to pick a palletized load in view of the pose of the horizontal surface that is to receive the load.

AMR 100 may include a plurality of sensors 150 that provide various forms of sensor data that enable the AMR to safely navigate throughout an environment, engage with objects to be transported, and avoid obstructions. In various embodiments, the sensor data from one or more of sensors 150 can be used for path navigation and obstruction detection and avoidance, including avoidance of detected objects, hazards, humans, other robotic vehicles, and/or congestion during navigation.

One or more of sensors 150 can form part of a two-dimensional (2D) or three-dimensional (3D) high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in a 3D model and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle.

Sensors 150 can include one or more stereo cameras 152 and/or other volumetric sensors, sonar sensors, radars, and/or LiDAR scanners or sensors 154a, 154b positioned about AMR 100, as examples. Inventive concepts are not limited to particular types of sensors, nor the types, configurations, and placement of the AMR sensors in FIGS. 1 and 2. In some embodiments, object movement techniques (i.e., dropping an object in the zone, removing an object from a zone) described herein are performed with respect to one or more of sensors 150, in particular, a combination of object detection sensors and load presence sensors. The object detection sensor(s) is/(are) configured to locate a position of an object withing the zone. An object detection sensor can be or include at least one camera, LiDAR, electromechanical, and so on. The load presence sensor(s) is/(are) configured to determine whether AMR 100 is carrying an object.

In the embodiment shown in FIG. 1, at least one of LiDAR devices 154a,b can be a 2D or 3D LiDAR device for performing safety-rated forward obstruction sensing functions. In alternative embodiments, a different number of 2D or 3D LiDAR devices are positioned near the top of AMR 100. Also, in this embodiment a LiDAR 157 is located at the top of the mast. In some embodiments LiDAR 157 is a 2D LiDAR used for localization or odometry-related operations.

The object detection and load presence sensors can be used in combination with others of the sensors, e.g., stereo camera head 152. Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

As shown in FIG. 2, AMR 100 includes three particular sensors 156, 158, and 165 (which may be among the sensors 150) that collect sensor data used in determining where to perform either a payload acquisition or deposition within a zone without prior knowledge or training of the location of objects within the zone.

Payload presence sensor 158 may perform 2D LiDAR operations or the like to perform a load presence sensing operation. In some embodiments, payload presence sensor 158 may be a physical paddle sensor or other sensor type to detect whether or not a load is being transported by the AMR, e.g., whether a load present on the forks. Payload presence sensor 158 can be used during picks to determine when to stop moving the forks 110 in order to avoid pushing a pallet or other object along the floor into other objects.

The object of interest detection sensor 156 can perform object of interest detection and/or reverse obstruction sensing functions. The object of interest detection sensor 156 can be coupled to carriage 114 or other movable portion of AMR 100 so that sensor 156 moves with the forks. Object of interest detection sensor 156 is obscured behind forks 110 when they are lowered to a floor height, in this embodiment. Object of interest detection sensor 156 is used to find objects in the region of interest that AMR 100 needs to stop next to—either to deposit a payload in the “drop” case or for the purpose of positioning an object of interest classification sensor 165 to be able to detect the object in the “pick” case. In some embodiments, object of interest detection sensor 156 may perform 3D LiDAR operations. In other embodiments, object of interest detection sensor 156 performs 2D LiDAR operations, but is not limited thereto these implementations, so long as object of interest detection sensor 156 can determine or sense a position of an object on the floor in a region of interest. In some embodiments, object of interest classification sensor 165, also referred to as a pallet detection sensor in the case of a forklift or lift truck, is arranged to determine the pose of a pickable object, such as a pallet, cage, container, or the like that have slots or pockets to receive forks 110 of AMR 100.

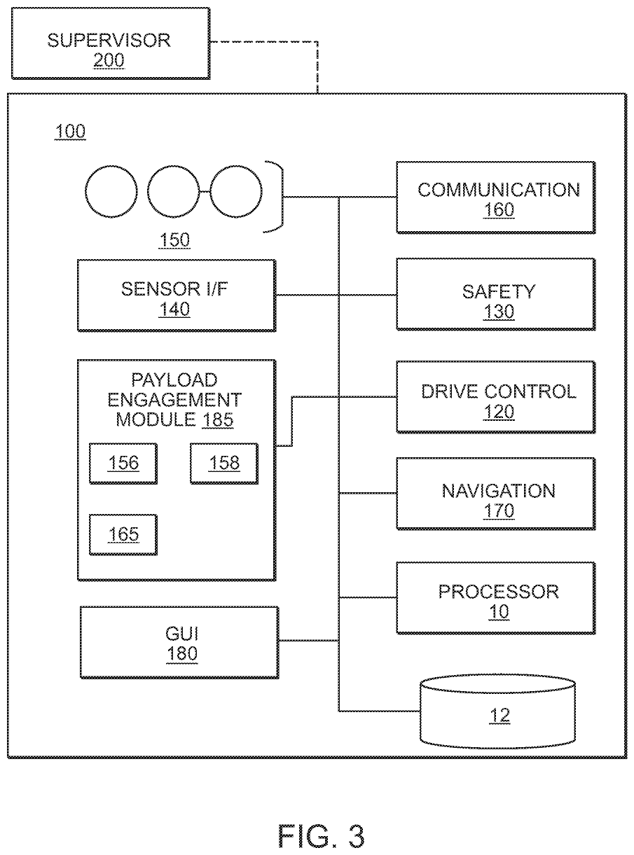

Object of interest classification sensor 165 may include a camera or the like to verify that the object being detected is a payload that the AMR can acquire. Other sensors in lieu of a camera may be used. In some embodiments, one or more sensors can communicate with the payload engagement system (see FIG. 3) to determine both if the object is one that can be acquired by forks 110 of AMR 100, and the pose of that object relative to AMR 100. The pose indicates an orientation of the object, e.g., pallet, at the location within the zone and is useful for the AMR in determining whether it can align the forks to safely pick the object. Therefore, in some embodiments, the object of interest classification sensor 165 determines if an object is pickable. For example, sensor 165 may send images to the payload engagement module 185 to determine if an object can be engaged by forks 100, such as a pallet, cage, container, or the like that have slots or pockets to receive forks 110 of AMR 100.

FIG. 3 is a block diagram of components of an embodiment of AMR 100 of FIGS. 1 and 2, incorporating technology for moving and/or transporting objects (e.g., loads or pallets) to/from a predefined zone, in accordance with principles of inventive concepts. The embodiment of FIG. 3 is an example; other embodiments of AMR 100 can include other components and/or terminology. In the example embodiment shown in FIGS. 1-3, AMR 100 is a warehouse robotic vehicle, which can interface and exchange information with one or more external systems, including a supervisor system, fleet management system, and/or warehouse management system (collectively “supervisor 200”). In various embodiments, supervisor 200 could be configured to perform, for example, fleet management and monitoring for a plurality of vehicles (e.g., AMRs) and, optionally, other assets within the environment. Supervisor 200 can be local or remote to the environment, or some combination thereof.

In various embodiments, supervisor 200 can be configured to provide instructions and data to AMR 100, and to monitor the navigation and activity of the AMR and, optionally, other AMRs. The AMR can include a communication module 160 configured to enable communications with supervisor 200 and/or any other external systems. Communication module 160 can include hardware, software, firmware, receivers, and transmitters that enable communication with supervisor 200 and any other external systems over any now known or hereafter developed communication technology, such as various types of wireless technology including, but not limited to, Wi-Fi, Bluetooth™, cellular, global positioning system (GPS), radio frequency (RF), and so on.

As an example, supervisor 200 could wirelessly communicate a path for AMR 100 to navigate for the vehicle to perform a task or series of tasks. The path can be relative to a map of the environment stored in memory and, optionally, updated from time-to-time, e.g., in real-time, from vehicle sensor data collected in real-time as AMR 100 navigates and/or performs its tasks. The sensor data can include sensor data from one or more sensors described with reference to FIGS. 1 and 2. As an example, in a warehouse setting the route could include a plurality of stops along a route for the picking and loading and/or the unloading of objects, e.g., payload of goods. The route can include a plurality of path segments, including a zone for the acquisition or deposition of objects. Supervisor 200 can also monitor AMR 100, such as to determine the AMR's location within the environment, battery status and/or fuel level, and/or other operating, vehicle, performance, and/or load parameters.

As described above, a route may be developed by training AMR 100. That is, an operator may guide AMR 100 through a travel path within the environment while the AMR, through a machine-learning process, learns and stores the route for use in task performance and builds and/or updates an electronic map of the environment as it navigates, with the route being defined relative to the electronic map. The route may be stored for future use and may be updated, for example, to include more, less, or different locations, or to otherwise revise the travel route and/or path segments, as examples.

As is shown in FIG. 3, in example embodiments, AMR 100 includes various functional elements, e.g., components and/or modules, which can be housed within housing 115. Such functional elements can include at least one processor 10 coupled to at least one memory 12 to cooperatively operate the vehicle and execute its functions or tasks. Memory 12 can include computer program instructions, e.g., in the form of a computer program product, executable by processor 10. Memory 12 can also store various types of data and information. Such data and information can include route data, path data, path segment data, pick data, location data, environmental data, and/or sensor data, as examples, as well as the electronic map of the environment. In some embodiments, memory 12 stores relevant measurement data for use by a payload engagement module 185 that exchanges information with the sensors, in particular, object detection sensor 156, load presence sensor 158, and object of interest classification sensor 165 of FIGS. 1 and 2 and, using the sensors 156, 158, 165, determines a location of an object within a predefined zone in order to determine where to perform a deposition in a load drop mode and a removal in a load engagement mode within the zone.

In this embodiment, processor 10 and memory 12 are shown onboard AMR 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of AMR 100 can further include a navigation module 170 configured to access environmental data, such as the electronic map, and path information stored in memory 12, as examples. Navigation module 170 can communicate instructions to a drive control subsystem 120 to cause AMR 100 to navigate its route by navigating a path within the environment. During vehicle travel, navigation module 170 may receive information from one or more sensors 150, via a sensor interface (I/F) 140, to control and adjust the navigation of the AMR. For example, sensors 150, 156, 158, 165, etc. may provide 2D and/or 3D sensor data to navigation module 170 and/or drive control subsystem 120 in response to sensed objects and/or conditions in the environment to control and/or alter the AMR's navigation. As examples, sensors 150, 156, 158, 165, etc. can be configured to collect sensor data related to objects, obstructions, equipment, goods to be picked, hazards, completion of a task, and/or presence of humans and/or other robotic vehicles. An object can be a pickable or non-pickable object within a zone used by the vehicle, such as a palletized load, a cage with slots for forks at the bottom, a container with slots for forks located near the bottom and at the center of gravity for the load. Other objects can include physical obstructions in a zone such as a traffic cone or pylon, a person, and so on.

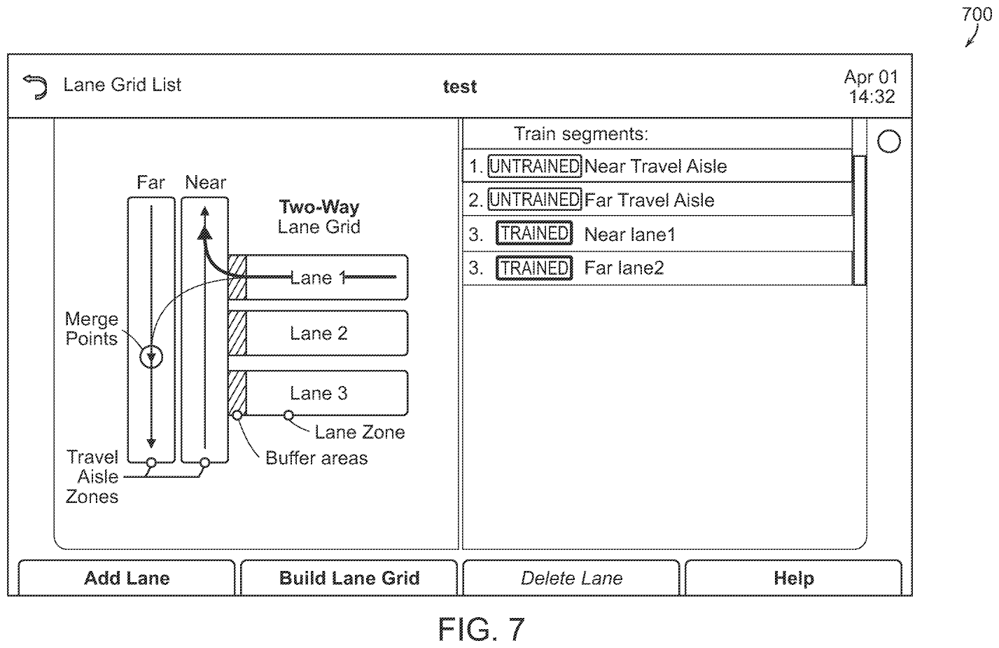

The AMR may also include a graphical user interface (GUI) module 180 or other display for human user interaction, for example, see display 700 shown in FIG. 7, that is configured to receive human operator inputs, e.g., a pick or drop complete input at a stop on the path. Other human inputs could also be accommodated, such as inputting map, path, and/or configuration information. In various embodiments, the GUI module 180 can be used to build a route and define and/or determine a zone on the route, with an exit and/or entrance, a near bound, and a far bound.

A safety module 130 can also make use of sensor data from one or more of sensors 150, in particular, LiDAR scanners 154, to interrupt and/or take over control of drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

In various embodiments, payload engagement module 185 can process sensor data from one or more of the sensors 150, in particular, object of interest detection sensor 156, load presence sensor 158, and object of interest classification sensor 165 and generate signals to control one or more actuators that control AMR 100. For example, payload engagement module 185 can be configured to robotically control carriage 114 to pick and drop payloads. In some embodiments, payload engagement module 185 can be configured to control and/or adjust position and orientation of the load engagement portion of AMR 110, e.g., forks 110 and/or carriage 114. These adjustments can be based on, at least on part, a pose of the object to be picked.

As shown in FIGS. 1-3, in various embodiments, the system can comprise a mobile robotics platform, such as an AMR, at least one sensor 150 configured to collect/acquire point cloud data, such as a LiDAR scanner or 3D camera; and at least one local processor 10 configured to process, interpret, and register the sensor data relative to a common coordinate frame. For example, scans from the sensor 150, e.g., LiDAR scanner or 3D camera, are translated and rotated in all six degrees of freedom to align to one another and create a contiguous point cloud. To do this, a transform is applied to the data. The sensor data collected by sensors 150 can represent objects using the point clouds, where points in a point cloud represent discrete samples of the positions of the objects in 3-dimensional space. AMR 100 may respond in various ways depending upon whether a point cloud based on the sensor data includes one or more points impinging upon, falling within an envelope of, or coincident with the 3-dimensional path projection (or tunnel) of AMR 100.

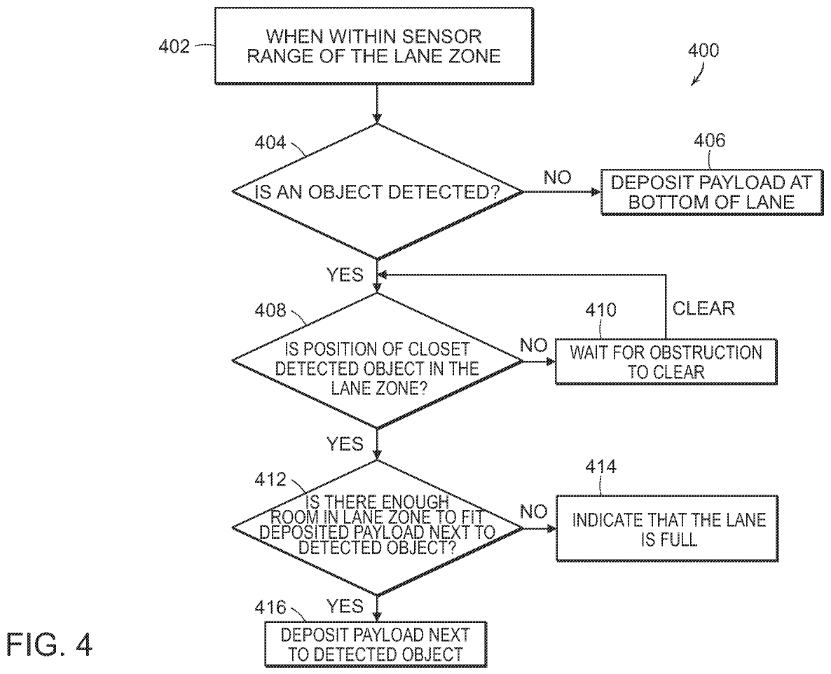

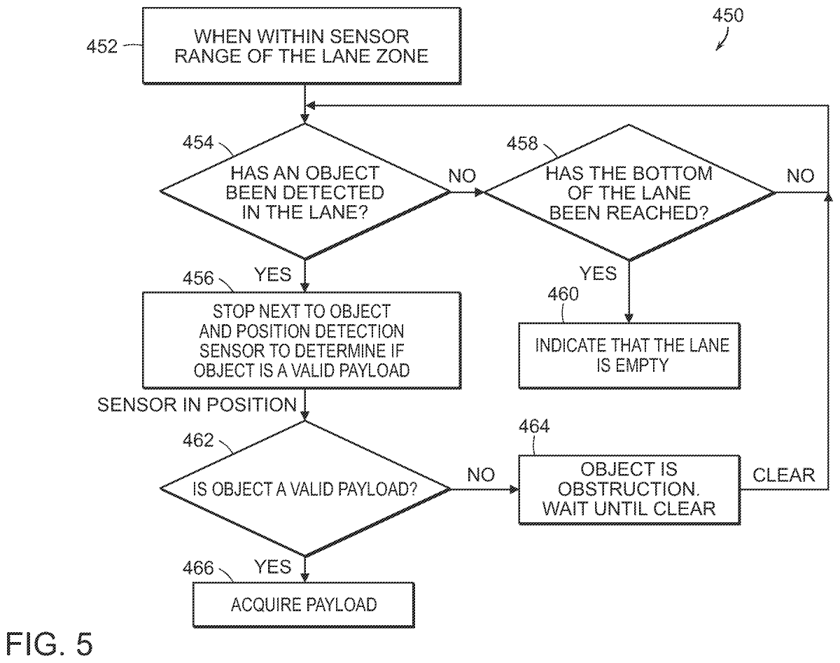

Using the payload engagement module 185 and other components of the AMR 100, FIG. 4 describes an embodiment of a method 400 for determining reachability of a location within a zone at which an AMR 100 can drop off an object, in accordance with aspects of the inventive concepts, and FIG. 5 describes an embodiment of a method 450 for determining reachability of a location within a zone at which an AMR 100 is expected to pick up an object. In these embodiments, the zone is a lane zone. As used herein, a lane zone is a type of zone that is linear or substantially linear where a payload may be acquired or deposited.

Referring to method 400 illustrated in FIG. 4, the sensors 156, 158, 165 of an AMR 100 shown in FIGS. 1-3 can be used to determine the location of objects within a lane zone to determine where to perform an action, in particular, where to drop off an object.

At block 402, a determination is made by the payload engagement module that the AMR 100 is within a sensor range of a lane zone of interest. That is, AMR 100 may have navigated a trained route, which may or may not have included intermediate dynamic adjustments, and then sensed its proximity to the desired lane zone on a path segment of the trained route. The location of the lane zone can form part of the AMR's trained route, while individual locations within the lane zone are not defined by the trained route. As a result, the particular location to drop the payload is determined by the AMR once it is within the lane zone. In the lane zone, during deposition (or drop) operations, payloads can continue to be added to the lane until there is no longer enough physical space in the lane zone to fit a full payload, plus a predetermined separation distance between dropped payloads. During a deposition operation, there is no specific location within the lane zone that is known ahead of time, a priori, for dropping the payload. The location of zone on the route can be specified during training by indicating the position of the lane zone entrance along the path. The lane zone can also have a predefined start and end, wherein the lane can have a predefined near bound and a far bound.

With respect to entering and exiting the zone, in some embodiments, the exit position is trained as only the forward motion is trained in a training run. The reverse portion of the path, along with the zone entrance, are automatically generated by reversing the forward path, and placing the entrance at the equivalent position to where the exit was trained. An object of interest detection sensor 156 may be activated for reverse sensing operations.

At decision box 404, a determination is made of whether an object is detected within the lane zone. For example, the object may be another pallet with payload or other pickable object, such as a cage, box, and so on. If an object is not detected within the lane, then method 400 proceeds to block 406, where the payload is deposited at the bottom (or far bound) of the lane. If an object is detected, then method 400 proceeds to decision box 408, where payload engagement module 185 attempts to determine a position of the closest detected object in the lane zone. If the position of the closest detected object cannot be determined, then AMR 100 is obstructed prior to the near bounds, and at block 410 AMR 100 waits for the obstruction to clear. If the position of the closest detected object is determined, which could be a palletized load previously dropped in the lane, then method 400 proceeds to decision box 412 where the payload engagement module 185 determines whether there is sufficient room in the lane zone to fit its payload next to the detected object. AMR 100 can collect sensor data to determine if a location adjacent to the detected object has sufficient dimensions to receive the AMR's payload, while maintaining a predetermine separation distance from the detected object.

If there is not enough room in the lane zone, then method 400 proceeds to block 414, where payload engagement module 185 generates a signal indicating that the lane is full. In some embodiments, the signal may cause a message to be displayed on a graphical user interface on the AMR or elsewhere, indicating that the lane is full. In some embodiments, the signal may be sent to supervisor 200 to request a new lane zone. If there is enough room in step 412, then method 400 proceeds to block 416, where the payload is deposited (dropped) next to the detected object, but preferably maintaining the predetermined separation distance.

Accordingly, in some embodiments, when depositing an object in the zone, once the location of the closest object is determined within the zone, the object establishes a new location for future actions in the zone. Reverse obstruction sensing is set to stop at a distance that allows for the desired separation distance between objects in the zone. Sensors are used to find the closest object within the zone. Once the closest object has been determined, the location to drop the object is calculated based on the desired separation distance of objects along with the expected length of the object. The desired separation distance can be a predetermined minimum separation distance between objects that is known to or stored within AMR 100 in advance, for example.

If no object has been detected within the zone, the farthest location or bound within the zone will be used. In various embodiments, the lane zone can include both near and far bounds in which it is acceptable to place the object, these bounds can be trained while the locations within those bounds are untrained. If AMR 100 is obstructed prior to the near bounds, it will stop and wait for the obstruction to clear. If AMR 100 is obstructed within those bounds, the object will be deposited or dropped off If AMR 100 reaches the far end of the bounds, AMR 100 will stop and deposit the object. Once the object is deposited, AMR 100 will exit the zone, this can be accomplished by reversing direction and exiting where it entered. In various embodiments, the exit point of a lane zone is the same as an entrance point. In other embodiments, the exit point and entrance point can be in different locations of the zone.

Referring to method 450 illustrated in FIG. 5, the sensors 500 of an AMR 100 shown in FIGS. 1-3 can be used to determine where to perform another action, namely, determining reachability of a position at which an AMR 100 is expected to pick up an object.

At block 452, similar to block 402 of FIG. 4, a determination is made by the payload engagement module of whether AMR 100 is within a sensor range of a lane zone of interest, or a zone where a payload may be acquired without specific locations within the zone being defined. That is, AMR 100 may have navigated a trained route, which may or may not have included intermediate dynamic adjustments, and then sensed its proximity to the desired lane zone on a path segment of the trained route. The lane zone can form part of the AMR's trained route, while individual locations within the lane zone are not defined by the trained route. As a result, a particular location to pick the payload is determined by the AMR once it is within the lane zone.

At decision box 454, payload engagement module 185 determines whether a payload object has been detected by sensors 150 of the AMR in the predetermined lane zone. That is, the lane zone and its bounds can be trained, but the locations within the lane zone are not trained. If yes in step 454, then method 450 proceeds to block 456 where the AMR 100 stops next to the detected object and pallet detection sensor 165 is activated to determine if the object is a valid payload object. A valid payload object may be a payload designated for pickup by the AMR. Thus, in various embodiments, the AMR and/or payload engagement module 185 can include object identification functionality. If, at decision box 454, a payload object has not been detected in the lane zone, then method 450 proceeds to decision box 458 where a determination is made whether the bottom (far bound) of the lane has been reached. If not, then method 450 returns to decision box 454. If yes, then the method proceeds to block 460, where the lane zone is determined to be empty. In some embodiments, the payload engagement module can generate a signal indicating that the lane is empty. In some embodiments, the signal could be used to generate a display on the graphical user interface indicating that the lane is empty, so no object is available for pickup. In some embodiments, the signal could be transmitted to supervisor 200.

Returning to block 456, the position detection sensor is in position, and at decision box 462 the sensor collects information, for example, images to determine if the object is a valid payload, e.g., using object identification functionality. Such object identification functionality could compare sensor data with data describing the payload object to be picked. If no in step 462, then method 450 proceeds to block 464 where the object cannot be identified as a valid payload. In various embodiments, the AMR and/or payload engagement module 185 determines the object to be an obstruction. Thus, AMR 100 is obstructed and, at block 464, AMR 100 waits for the obstruction to clear. Method 450 can return to decision box 458 or 454 when the obstruction is cleared. If at decision box 462 the object is determined to be a valid payload, then method 450 proceeds to block 466, where the payload is acquired.

In various embodiments, when removing a payload object from the zone, once the position of the closest object is determined in the zone, sensing can be adjusted in order to be able to remove that object from the zone. Reverse obstruction sensing is set to stop at a distance ideal for performing classification of objects. Sensors are used to find the closest object within the zone. If AMR 100 reaches the end of the zone without finding an object, it will not attempt to acquire any object. If AMR 100 is obstructed, it will attempt to classify the obstruction to determine if it is a payload object or not. If it is not able to classify the obstruction as an appropriate object, the AMR 100 will remain stopped until the obstruction clears. If it is able to so classify the obstruction as a pickable object, it will proceed to the next step. Classification can include both determining whether the object is of the right type to be acquired (a known object), as well as if it is in a position or pose where it can be acquired. For example, if the object is placed too far off to the side to safely be acquired, it will not be classified as a pickable object. Once a pickable object is discovered within the zone, sensing will be adjusted to attempt to acquire the object, and a bounding range of positions for where the AMR 100 will physically contact the object will be determined. If the AMR 100 reaches the far end of the bounds without detecting the presence of the object with the AMR's manipulator, it will stop and signal an event to indicate that the object was not found. If an object is detected as being in contact with the AMR's manipulator within the bounds, AMR 100 will stop and perform acquisition of the object. In various embodiments, once the object has been acquired, AMR 100 will proceed to exit the zone, e.g., from where it entered, by reversing direction.

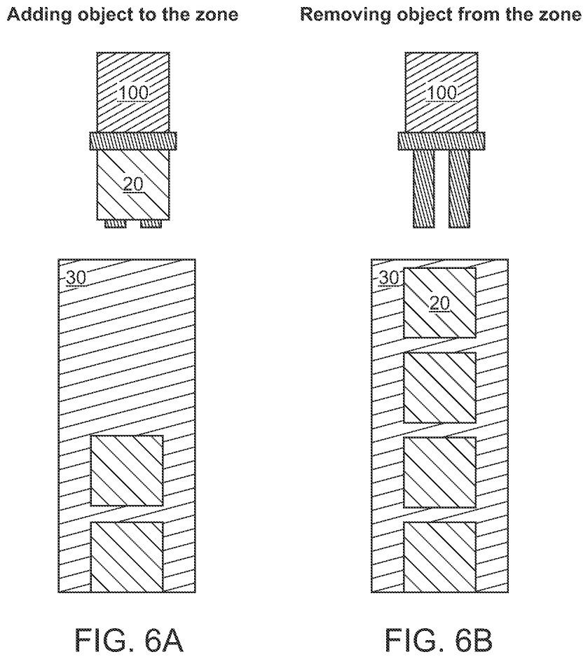

FIG. 6A is a diagram of an embodiment of an AMR 100 performing load drop off of a load 20 to a specified lane zone 30 in accordance with an embodiment of method 400 of FIG. 4. FIG. 6B is a diagram of an embodiment of AMR 100 performing a load pick-up operation from the specified lane zone 30 of FIG. 2A, in accordance with an embodiment of method 450 of FIG. 5. AMR 100 may be similar to or the same as the AMR 100 described in FIGS. 1-4, and therefore, details are not repeated for brevity.

In some embodiments, a Point Cloud Library (PCL) can be used for point cloud representation and basic manipulation of the sensor data. For example, the AMR may have at least one sensor 150 configured to collect/acquire point cloud data, such as a LiDAR scanner or 3D camera. In some embodiments, the PCL is not used. In some embodiments, the systems and methods described herein do not use open-source software. In some embodiments, the systems and/or methods described herein can leverage several open-source libraries for various parts of the system/method being disclosed.

In some embodiments, a pallet detection system is used to perform object-of-interest detection for material acquisition. This can be used to determine if an object is a packable object. In some embodiments, a different system for detecting objects of interest is used.

In some embodiments, an interest classification sensor 165, such as an industrial 3D camera, e.g., manufactured by IFM, but not limited thereto, can be used with the pallet detection system (PDS). In some embodiments, a different sensor is used such as sensor 160, 154a, or 154b. In some embodiments, a different pallet detection system can be used.

FIG. 7 is an example of an GUI 700 for training an AMR. The user interface can be used to mark locations in an electronic representation of an environment encompassing the zone. For example, during a training operation, a location at the end of each lane segment is marked, which may serve as merge points with a travel aisle. Each lane is trained where they will merge along the travel aisle. If there are two two-way travel aisles, the training can be performed from the back of each lane to where each lane merges with the far travel aisle. From the screen, a user can select a travel aisle to train. The screen also includes a button to allow a user to add a lane identified for a drop-off or pickup on a route, where the AMR can perform a pickup or drop-off operation according to the method 400 or 450, respectively. GUI 700 can be used to train a zone, such as a lane zone, by defining the zone's location on the trained route, as well as its entrance/exit, far bound and near bound. Other aspects of the zone could also be predetermined and into, but the zone is trained without defining individual locations within the zone for dropping or picking objects. In that sense, the locations within the zone are undefined or, put differently, the area within the zone amounts to open, undefined space.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can be combined in any given way.

Below follows an itemized list of statements describing embodiments in accordance with the inventive concepts:
1. A method executable by an autonomous mobile robot (AMR), the method comprising:
   training the AMR to auto-navigate to a zone where at least one task is to be performed, the zone defining a region as an open area without defined internal locations;
   the AMR auto-navigating to the zone and, using one or more sensors, determining a presence of an object at a location within the zone; and
   if the AMR is tasked with picking a load, removing the object from the location; or if the AMR is tasked with dropping a load, dropping the load at a position proximate to the object.
2. The method of statement 1, or any other statement or combination of statements, including using a set of object of interest sensors to locate the object within the zone.
3. The method of statement 1, or any other statement or combination of statements, wherein the set of object of interest sensors includes one or more of two dimensional (2D) LiDAR sensors and/or three dimensional (3D) LiDAR sensors.
4. The method of statement 1, or any other statement or combination of statements, including using a set of payload presence sensors to determine if the AMR is carrying a load.
5. The method of statement 1, or any other statement or combination of statements, wherein the set of payload sensors includes one or more of 2D LiDAR sensors and/or physical paddle sensors.
6. The method of statement 1, or any other statement or combination of statements, wherein determining the presence of the object includes determining the location of the object closest to the AMR and within the zone.
7. The method of statement 1 or 6, or any other statement or combination of statements, wherein training the AMR to auto-navigate to the zone includes processing user inputs received via a user interface device to mark an entrance and/or exit of the zone in an electronic representation of an environment.
8. The method of statement 1 or 7, or any other statement or combination of statements, wherein the user interface device is onboard, forming part of the AMR.
9. The method of statement 1 or 7, or any other statement or combination of statements, wherein the user interface device is offboard, separate from the AMR.
10. The method of statement 1 or 7, or any other statement or combination of statements, wherein training the AMR further comprises defining the zone as having a near bound and a far bound that define space within which the load can be dropped or picked.
11. The method of statement 1 or 10, or any other statement or combination of statements, wherein when dropping the load, if no object is determined by the one or more sensors, designating a farthest position within the zone as the position, the farthest position being at the far bound.
12. The method of statement 1 or 11, or any other statement or combination of statements, further comprising, in response to the AMR determining an object as an obstruction prior to the near bound, the AMR stopping and waiting for the obstruction to clear before navigating into the zone.
13. The method of statement 1, 10, 11 or 12, or any other statement or combination of statements, further comprising, in response to the AMR carrying the load reaching the far bound, the AMR determining the far bound to be the position and dropping the load.
14. The method of statement 1, 11 or 13, or any other statement or combination of statements, wherein dropping the load includes determining the position to be at a separation distance from the object.
15. The method of statement 1 or 14, or any other statement or combination of statements, including using reverse obstruction sensing of the AMR to set a stop distance that maintains the separation distance between the object and the load when dropped at the position.
16. The method of statement 1, 14, or 15, or any other statement or combination of statements, including determining the position based on the separation distance and a length of the load.
17. The method of statement 1, or any other statement or combination of statements, wherein the location is a previously dropped load or a structural element comprising a wall, a column, a table, or a shelving rack.
18. The method of statement 1, or any other statement or combination of statements, wherein picking the load includes picking the load at the object closest to the AMR within the zone.
19. The method of statement 1 or 18 or any other statement or combination of statements, further comprising adjusting sensing by the one or more sensor to remove that load from the zone.
20. The method of statement 1, 2, 18, or 19, or any other statement or combination of statements, including using an object of interest sensor to perform reverse obstruction sensing of the AMR to set a stop distance for performing classification of the object.
21. The method of statement 1, or any other statement or combination of statements, including if the AMR reaches an end of the zone without sensing the object, the AMR aborting the task of picking the load.
22. The method of statement 1, or any other statement or combination of statements, including, in response to the AMR using an object of interest classification sensor to perform sensing of the object in the zone, attempting to classify the object as an obstruction or a pickable load.
23. The method of statement 1 or 22, or any other statement or combination of statements, including, if the AMR classifies the object as an obstruction, the AMR pausing or stopping until the obstruction clears.
24. The method of statement 1 or 22, or any other statement or combination of statements, including, if the AMR classifies the object as a known object, the AMR determining whether the known object is a pickable load and if the pickable load is in a pose where it can be picked.
25. The method of statement 1 or 22, or any other statement or combination of statements, including, if the AMR classifies the object as a pickable load, bounding a range of positions where an AMR manipulator can physically engage the pickable load.
26. The method of statement 1 or 22, or any other statement or combination of statements, including if the AMR reaches a far end of the range without detecting the presence of the pickable load with an AMR manipulator, stopping and signaling that the load cannot be picked.
27. The method of statement 25, or any other statement or combination of statements, including if the load is detected within the range as being in contact with the AMR manipulator, the AMR stopping and picking the pickable load.
28. The method of statement 1, or any other statement or combination of statements, wherein the zone includes a lane comprising a plurality of linearly arranged locations.
29. The method of statement 1, or any other statement or combination of statements, including training the AMR to navigate the zone by reversing direction to exit the zone after a drop task or a pick task.
30. An autonomous mobile robot (AMR), comprising:
   a chassis;
   a navigation system configured to auto-navigate the AMR to a zone where at least one task is to be performed;
   a plurality of sensors including a payload presence sensor, an object of interest detection sensor, and an object of interest classification sensor; and
   at least one processor configured to:
      define the zone as having an entrance and/or exit and an open area without defined internal locations to perform the at least one task, and
      exchange information with the plurality of sensors, and, using the sensors, configured to determine a location of an object within the zone and to determine where to perform a deposition in a load drop mode or a removal in a load engagement mode within the zone.
31. The AMR of statement 30, or any other statement or combination of statements, wherein the object is a pickable object comprising a pickable object including one of a pallet, a cage, or a container.
32. The AMR of statement 30, or any other statement or combination of statements, wherein the object of interest sensor is constructed and arranged to locate the object within the zone.
33. The AMR of statement 30, or any other statement or combination of statements, wherein the object of interest sensor includes one or more of two dimensional (2D) LiDAR sensors and/or three dimensional (3D) LiDAR sensors.
34. The AMR of statement 30, or any other statement or combination of statements, wherein the payload presence sensor is configured to determine if the AMR is carrying a load.
35. The AMR of statement 30, or any other statement or combination of statements, wherein the payload presence sensor includes one or more of 2D LiDAR sensors and/or physical paddle sensors.
36. The AMR of statement 30, or any other statement or combination of statements, wherein the object of interest classification sensor is configured to perform sensing of the object in the zone, and the at least one processor is configured to classify the object as an obstruction or pickable load.
37. The AMR of statement 30 or 36, or any other statement or combination of statements, wherein if the at least one processor classifies the object as an obstruction, the AMR is configured to pause or stop until the obstruction clears.
38. The AMR of statement 30 or 36, or any other statement or combination of statements, wherein if the at least one processor classifies the object as a known object, the AMR is configured to determine whether the known object is a pickable load to be acquired and if the pickable load is in a pose where it can be picked.
39. The AMR of statement 30 or 38, or any other statement or combination of statements, if the at least one processor classifies the object as a pickable load, bounding a range of positions where an AMR manipulator can physically engage the pickable load.
40. The AMR of statement 30 or 39, or any other statement or combination of statements, wherein if the AMR manipulator reaches a far end of the range without detecting the presence of the pickable load with the AMR is configured to pause or stop and generate a signal that the pickable load was not found.
41. The AMR statement 30 or 39, or any other statement or combination of statements, wherein if the pickable load is detected within the range as being in contact with the AMR manipulator, the AMR stopping and picking the pickable load.
42. The AMR of statement 30, or any other statement or combination of statements, wherein the at least one processor is further configured to define the zone as having a near bound and a far bound that define space within which the load can be dropped or picked.

What is claimed is:

1. A method executable by an autonomous mobile robot (AMR), the method comprising:
training the AMR to auto-navigate to a zone where at least one task is to be performed, the zone defining a region as an open area without defined internal locations;
the AMR auto-navigating to the zone and, using one or more sensors, determining a presence of an object at a location within the zone; and
if the AMR is tasked with picking a load, removing the object from the location; or
if the AMR is tasked with dropping a load, dropping the load at a position proximate to the object.

2. The method of claim 1, including using a set of object of interest sensors to locate the object within the zone, wherein the set of object of interest sensors includes one or more of two dimensional (2D) LiDAR sensors and/or three dimensional (3D) LiDAR sensors.

3. The method of claim 1, including using a set of payload presence sensors to determine if the AMR is carrying a load, wherein the set of payload sensors includes one or more of 2D LiDAR sensors and/or physical paddle sensors.

4. The method of claim 1, wherein determining the presence of the object includes determining the location of the object closest to the AMR and within the zone.

5. The method of claim 1, wherein training the AMR to auto-navigate to the zone includes processing user inputs received via a user interface device to mark an entrance and/or exit of the zone in an electronic representation of an environment.

6. The method of claim 1, wherein training the AMR further comprises defining the zone as having a near bound and a far bound that define space within which the load can be dropped or picked.

7. The method of claim 6, wherein when dropping the load, if no object is determined by the one or more sensors, designating a farthest position within the zone as the position, the farthest position being at the far bound.

8. The method of claim 6, further comprising, in response to the AMR determining an object as an obstruction prior to the near bound, the AMR stopping and waiting for the obstruction to clear before navigating into the zone.

9. The method of claim 6, further comprising, in response to the AMR carrying the load reaching the far bound, the AMR determining the far bound to be the position and dropping the load.

10. The method of claim 1, wherein dropping the load includes determining the position to be at a separation distance from the object.

11. The method of claim 10, including using reverse obstruction sensing of the AMR to set a stop distance that maintains the separation distance between the object and the load when dropped at the position.

12. The method of claim 10, including determining the position based on the separation distance and a length of the load.

13. The method of claim 1, wherein the object is a previously dropped load or a structural element comprising a wall, a column, a table, or a shelving rack.

14. The method of claim 1, wherein picking the load includes picking the load as the object closest to the AMR within the zone.

15. The method of claim 1, further comprising adjusting sensing by the one or more sensor to remove that load from the zone.

16. The method of claim 1, including using an object of interest sensor to perform reverse obstruction sensing of the AMR to set a stop distance for performing classification of the object.

17. The method of claim 1, including if the AMR reaches an end of the zone without sensing the object, the AMR aborting the task of picking the load.

18. The method of claim 1, including, in response to the AMR using an object of interest classification sensor to perform sensing of the object in the zone, attempting to classify the object as an obstruction or a pickable load.

19. The method of claim 18, including, if the AMR classifies the object as an obstruction, the AMR pausing or stopping until the obstruction clears.

20. The method of claim 18, including, if the AMR classifies the object as a known object, the AMR determining whether the known object is a pickable load and if the pickable load is in a pose where it can be picked.

21. The method of claim 18, including, if the AMR classifies the object as a pickable load, bounding a range of positions where an AMR manipulator can physically engage the pickable load.

22. The method of claim 21, including if the AMR reaches a far end of the range without detecting the presence of the pickable load with an AMR manipulator, stopping and signaling that the load cannot be picked.

23. The method of claim 21, including if the load is detected within the range as being in contact with the AMR manipulator, the AMR stopping and picking the pickable load.

24. The method of claim 1, wherein the zone includes a lane comprising a plurality of linearly arranged locations.

25. The method of claim 1, including training the AMR to navigate the zone by reversing direction to exit the zone after a drop task or a pick task.
